(19) United States
(12) Patent Application Publication
(10) Pub. No.: US 2022/0117062 A1
(43) Pub. Date: Apr. 14, 2022

(54) Method and System for Changing a Function of a Lighting Device

(71) Applicant: G&G LED, LLC, Clifton Park, NY (US)

(72) Inventors: Jason Baright, Clifton Park, NY (US); Caleb Peterson, Clifton Park, NY (US)

(21) Appl. No.: 17/450,337

(22) Filed: Oct. 8, 2021

Related U.S. Application Data
(60) Provisional application No. 63/091,042, filed on Oct. 13, 2020.

(51) Int. Cl. H05B 47/11; G05D 25/02; H05B 47/19

(52) U.S. Cl. CPC H05B 47/11; H05B 47/19; G05D 25/02

(57) ABSTRACT

Aspects of the invention relate generally to lighting devices and, more particularly, to a method and system for changing a function of a lighting device. In one embodiment, the invention provides a system comprising: at least one lighting device; a lighting controller connected to the at least one lighting device, the lighting controller being operable to control a function of the at least one lighting device; and an input controller connected to the lighting controller, the input controller including at least one receiving unit for receiving an input from an external device, wherein the input received from the external device changes the function of the at least one lighting device.

### CROSS-REFERENCE TO RELATED APPLICATIONS

This application claims priority to co-pending U.S. Provisional Patent Application Ser. No. 63/091,042, filed 13 Oct. 2020, which is hereby incorporated herein as though fully set forth.

### BACKGROUND

There are any number of situations in which it may be necessary or desirable to wirelessly control a lighting device, including augmenting a light display being carried out using the lighting device. In some cases, it may be desirable or necessary to grant such control to individuals without physical access to a lighting controller connected to the lighting device.

### SUMMARY

Aspects of the invention relate generally to lighting devices and, more particularly, to a method and system for changing a function of a lighting device.

In one embodiment, the invention provides a system comprising: at least one lighting device; a lighting controller connected to the at least one lighting device, the lighting controller being operable to control a function of the at least one lighting device; and an input controller connected to the lighting controller, the input controller including at least one receiving unit for receiving an input from an external device, wherein the input received from the external device changes the function of the at least one lighting device.

In another embodiment, the invention provides a method of changing a function of a lighting device, the method comprising: wirelessly connecting an external device to an input controller of a lighting control system connected to and operable to control a function of at least one lighting device; and using the external device, delivering a signal to the input controller, wherein the signal is capable of being operated on by the lighting control system to change the function of the at least one lighting device.

In still another embodiment, the invention provides a method of changing a function of a lighting device, the method comprising: wirelessly receiving, from an external device, an input signal; and executing, using a lighting controller connected to at least one lighting device, an operation based on the input signal to change a function of the at least one lighting device.

In still another embodiment, the invention provides a system comprising: at least one lighting device; and a lighting controller connected to the at least one lighting device, the lighting controller being operable to control a function of the at least one lighting device, wherein an input received from an external device changes the function of the at least one lighting device.

In yet another embodiment, the invention provides a method of changing a function of a lighting device, the method comprising: wirelessly connecting an external device to a lighting control system connected to and operable to control a function of at least one lighting device; and using the external device, delivering a signal to the lighting control system, wherein the signal is capable of being operated on by the lighting control system to change the function of the at least one lighting device.

In still yet another embodiment, the invention provides a method of changing a function of a lighting device, the method comprising: wirelessly receiving, from an external device, an input signal; and executing, using a lighting controller connected to at least one lighting device, an operation based on the input signal to change a function of the at least one lighting device.

### BRIEF DESCRIPTION OF THE DRAWINGS

These and other features of this disclosure will be more readily understood from the following detailed description of the various aspects of the disclosure taken in conjunction with the accompanying drawings that depict various embodiments of the disclosure, in which:

FIG. 1 is a schematic view of a system according to an embodiment of the invention.

FIG. 2 is a flow diagram of a method according to an embodiment of the invention.

It is noted that the drawings of the disclosure are not to scale. The drawings are intended to depict only typical aspects of the disclosure, and therefore should not be considered as limiting the scope of the disclosure. In the drawings, like numbering represents like elements between the drawings.

### DETAILED DESCRIPTION

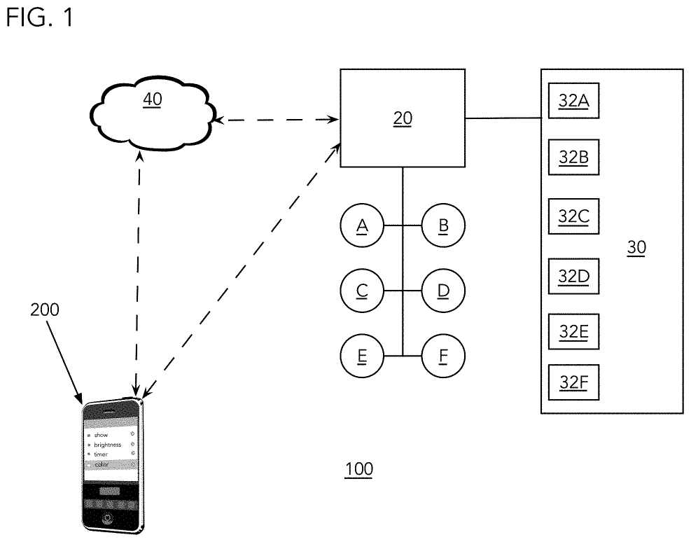

FIG. 1 shows a schematic of a system 100 according to an embodiment of the invention. The system 100 includes a plurality of lighting devices A-F connected to a lighting controller 20. Lighting devices A-F may include any type of lighting device. In preferred embodiments, any or all of lighting devices A-F comprises or includes a light emitting diode (LED) lighting device. In particularly preferred embodiments, such LED lighting devices are capable of emitting light of varying colors. In FIG. 1, the system 100 is shown comprising a plurality of lighting devices A-F for the purposes of explaining various aspects of the invention. It should be appreciated, however, that systems according to the invention may include any number of lighting devices, including a single lighting device.

The lighting controller 20 may include hardware, software, or both, adapted to control one or more functions of lighting devices A-F, as will be understood by one skilled in the art. This may include, for example, a memory storing computer executable code for controlling a function of a lighting device, a processor for executing such code, an input/output (I/O) interface, and a communications interface.

As such, the lighting controller 20 may constitute or include a computing device, such as is known in the art, in which the processor executes code stored in the memory, reading and/or writing data from/to the memory and/or the I/O interface. The I/O interface enables a user to interact with the lighting controller 20 and/or for the lighting controller 20 to directly access an Internet or wireless network 40. The communications interface provides a communications link between each component of the lighting controller 20.

According to some embodiments, the system 100 further includes an input controller 30 connected to the lighting controller 20. This, however, is neither necessary nor essential. Any of the functionality described below with respect to the input controller 30 may be incorporated directly into the lighting controller 20.

The connection between the input controller 30 and the lighting controller 20 may constitute or include a wireless connection or may constitute or include a wired connection. In some embodiments of the invention, the input controller 30 is integrated into the lighting controller 20, although this is neither necessary nor essential.

The input controller 30 includes one or more receiving units 32A-F for receiving discrete inputs or signals related to the control of lighting devices A-F.

An external device, shown in FIG. 1 as a mobile phone 200, is capable of connecting to lighting controller 20 directly or via the Internet or a wireless network 40. For the sake of simplicity, only one external device is shown in FIG. 1, although it should be appreciated that lighting controller 20 may be capable of simultaneous connection to any number of external devices of any kind, including any number of mobile phones.

According to some embodiments of the invention, external devices may connect directly to the input controller 30 and/or its receiving unit(s) 32. According to other embodiments, external devices may connect to the input controller 30 and/or its receiving unit(s) 32A-F via the Internet or wireless network 40. Such methods of connection are well understood in the art and not described in further detail here.

Regardless of the method by which an external device connects to system 100, the external device (e.g., mobile phone 200 in FIG. 1) may be employed by a user to change one or more aspect of the operation of one or more of the lighting devices A-F.

For example, the lighting controller 20 may execute stored computer code in order to conduct a light display, a lighting show, or some other use of lighting devices A-F, wherein each lighting device emits a lighting signal in a sequence (e.g., first lighting device A, then lighting device B, then lighting device C, etc.) or of a particular color (e.g., lighting device A emits a red color, lighting device B emits a blue color, etc.). The mobile phone 200 may be employed, by its connection to the lighting controller 20, to alter or augment some aspect of the lighting display or show. For example, by sending a signal from the mobile phone 200 to the lighting controller 20, the sequence in which the lighting devices A-F are illuminated may be changed or the color emitted by each lighting device A-F may be changed.

As should be understood from the above, any aspect of any of the lighting devices A-F that would be subject to control using the lighting controller 20 may similarly be controlled by a user using an external device connected to the input controller 30 and/or one or more of its receiving unit(s) 32A-F. Lighting intensities, timings, or even whether a particular lighting device is activated are other aspects so controllable.

As noted above, the external device may connect to the lighting controller 20 using, for example, a web browser. Access to the lighting controller 20 may be via a hyperlink. The link, in turn, may be provided to a user of the external device using, for example, a scannable image, such as a QR code. Other devices for providing such a link are known and will be apparent to one skilled in the art.

According to other embodiments of the invention, the link may be delivered to the external device via a message, such as an e-mail or text message.

It should be noted that nothing in the above should be construed as precluding the use of wired devices to access and control system 100, including lighting controller 20 and/or input controller 30, in addition to the use of external devices.

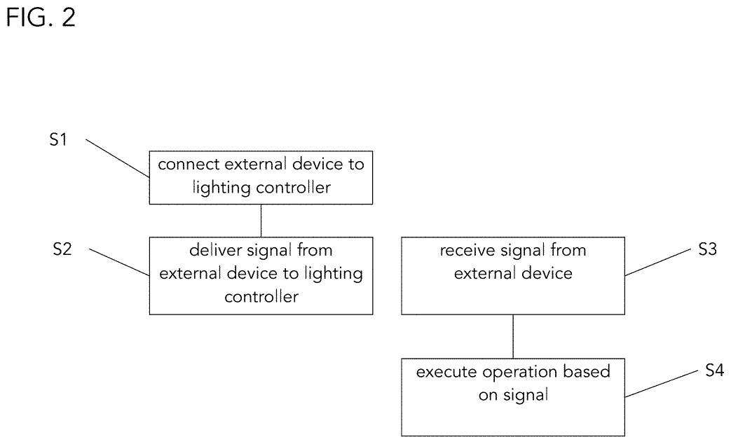

FIG. 2 shows a flow diagram of a method according to an embodiment of the invention. At S1, a user connects an external device 200 to the lighting controller 20. At S2, the external device is used to deliver a signal to the lighting controller 20. As should be clear from the above, S1 and S2 occur at the user's side of the method.

At S3, the signal sent from the external device is received at the lighting controller 20. At S4, the system 100 executes an operation based on the signal received at S3, as described above. As should be clear from the above, S3 and S4 occur at the system side of the method.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

This written description uses examples to disclose the invention, including the best mode, and also to enable any person skilled in the art to practice the invention, including making and using any devices or systems and performing any related or incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A system comprising:
at least one lighting device; and
a lighting controller connected to the at least one lighting device, the lighting controller being operable to control a function of the at least one lighting device,
wherein an input received from an external device changes the function of the at least one lighting device.

2. The system of claim 1, further comprising:
an input controller connected to the lighting controller, the input controller including at least one receiving unit for receiving the input from the external device.

3. The system of claim 2, wherein the input controller includes a plurality of receiving units for receiving inputs from a plurality of external devices.

4. The system of claim 1, wherein the function includes a color of the at least one lighting device.

5. The system of claim 4, wherein the input from the external device includes a signal to change a color of the at least one lighting device.

6. The system of claim 1, wherein the function includes a light intensity of the at least one lighting device.

7. The system of claim 6, wherein the input from the external device includes a signal to change the light intensity of the at least one lighting device.

8. The system of claim 1, wherein the function includes a lighting pattern of the at least one lighting device.

9. The system of claim 8, wherein the input from the external device includes a signal to change the lighting pattern of the at least one lighting device.

10. The system of claim 1, wherein the external device is a mobile phone.

11. The system of claim 10, wherein the input is sent from the mobile phone to the receiving unit of the input controller using a web browser.

12. The system of claim 11, wherein a link to send the input from the mobile phone is accessed using a scannable image.

13. The system of claim 12, wherein the scannable image includes a QR code.

14. The system of claim 11, wherein a link to send the input from the mobile phone is accessed from a message delivered to the mobile phone.

15. The system of claim 10, wherein the input is sent from the mobile phone to the receiving unit of the input controller using a mobile application on the mobile phone.

16. A method of changing a function of a lighting device, the method comprising:
wirelessly connecting an external device to a lighting control system connected to and operable to control a function of at least one lighting device; and
using the external device, delivering a signal to the lighting control system,
wherein the signal is capable of being operated on by the lighting control system to change the function of the at least one lighting device.

17. The method of claim 16, wherein the function is selected from a group consisting of: a color of the at least one lighting device, a light intensity of the at least one lighting device, and a lighting pattern of the at least one lighting device.

18. A method of changing a function of a lighting device, the method comprising:
wirelessly receiving, from an external device, an input signal; and
executing, using a lighting controller connected to at least one lighting device, an operation based on the input signal to change a function of the at least one lighting device.

19. The method of claim 18, wherein the external device is a mobile phone.

20. The method of claim 18, wherein the function is selected from a group consisting of: a color of the at least one lighting device, a light intensity of the at least one lighting device, and a lighting pattern of the at least one lighting device.
